(19) United States
(12) Patent Application Publication
(10) Pub. No.: US 2009/0321646 A1
(43) Pub. Date: Dec. 31, 2009

(54) NON-DESTRUCTIVE ANALYSIS BY VIS-NIR SPECTROSCOPY OF FLUID(S) IN ITS ORIGINAL CONTAINER

(76) Inventor: Daniel Cozzolino, South Australia (AU)

Correspondence Address: WILMERHALE/BOSTON, 60 STATE STREET, BOSTON, MA, 02109, US

(21) Appl. No.: 11/988,587

(22) PCT Filed: Jul. 12, 2006
(86) PCT No.: PCT/AU2006/000984

§ 371 Date: Aug. 13, 2008

(30) Foreign Application Priority Data
Jul. 12, 2005 (AU) 2005100565

(51) Int. Cl. G01N 21/35; G01J 3/28

(52) U.S. Cl. 250/339.05

(57) ABSTRACT

A method is described for assessing at least one characteristic of a fluid held in a container that utilizes visible—near infrared (VIS-NIR) spectroscopy in combination with chemometrics. A method is also provided for calibrating VIS-NIR analyser(s) operating in transflectance mode for one or more characteristics of a fluid.

### CROSS-REFERENCE TO RELATED APPLICATIONS

The present application claims priority to PCT/AU2006/000984 filed on Jul. 12, 2006 which claims priority to Australian Innovation Patent Application No. 2005100565 filed on 12 Jul. 2005, the content of which is incorporated herein by reference.

### FIELD OF THE INVENTION

The present invention relates to an optical method of analysing fluids. In particular, the present invention relates to an in-container method of analysing fluids; for example wine, using visible (VIS) and near infrared (NIR) spectroscopy.

### BACKGROUND OF THE INVENTION

Present methods for assessing quality indicators of natural and mass produced manufactured products require extensive sample preparation and multi-step methodologies.

With existing spectroscopic techniques, such as infrared spectroscopy, absorbance measurements of samples are performed in a non-coloured, transparent quartz, glass or plastic cuvette with a flat surface that is held perpendicular to the light beam and with wall of controlled thickness. The product undergoing analysis is removed from its container, placed into the cuvette and the analysis performed. The time involved in preparing and performing such analysis and the associated mathematical computations have typically been too long for adequate analysis of mass produced items, particularly while still on the production line. There can also be significant costs associated with existing techniques where production lines may need to be stopped or packaged products discarded if subsequent testing reveals potential deficiencies in the product.

Viticulturists and winemakers are particularly interested in accessing analytical techniques which can quickly and efficiently measure grape and wine qualities. It is a longstanding wine industry practice to assess grape quality by measuring total soluble solids (TSS, predominantly sugars, measured as Brix), acidity (measured as pH and titratable acidity), visual inspection and grading by tasting. With respect to wine quality, measure of pH, alcohol, reducing sugars, free and total sulphur dioxide, aroma profiles and colour are traditional methods used by the wine industry. Traditional techniques however are time consuming and result in the destruction of the sample. It would be useful if wine could be assessed “in-bottle”, so the wine will not destroyed facilitating product verification, and changes to the wine due to closure failure, such as oxidation of the wine, wine haze formation, etc.

Recent developments in rapid measurement techniques combined with chemometrics have led to techniques which can be used to analyse wines which reduce analytical time from hours to minutes, but still require sample preparation. One emerging technique is near infrared (NIR) spectroscopy which is a form of vibrational spectroscopy that is particularly sensitive to the presence of molecules containing C—H (carbon-hydrogen), O—H (oxygen-hydrogen), and N—H (nitrogen-hydrogen) groups. Therefore, constituents such as sugars and starch (C—H), moisture, alcohols and acids (O—H), and protein (N—H) can be quantified in liquids, solids and slurries.

NIR techniques are based on the measurement of the intensity of these absorbances in samples in the near infrared region of the electromagnetic spectrum. These intensities are compared to a calibration equation developed between the intensity of standard samples of known concentration and analytical results determined by standard (or “reference”) laboratory techniques. The calibration equation is then used to predict the analytical results from NIR spectra of new samples.

Chemometric methods based on eigenvalue decomposition of a data matrix are effective tools for analyzing correlations between spectral information and compositions and properties. Principal component analysis (PCA) and partial least squares in latent variables (PLS) are commonly used techniques.

Methodology has been developed to assess the quality of spirits and wine using transmission NIR spectroscopy [Dambergs, R. G.; Kambouris, A.; Francis, I. L.; Gishen, M. Rapid analysis of methanol in grape derived distillation products using near infrared transmission spectroscopy, Journal of Agricultural Food Chemistry 2002, 50, 3079-3084]; and to assess composition in both whole red grapes and homogenates [Dambergs, R. G.; Cozzolino, D.; Esler, M. B.; Cynkar, W. U.; Kambouris, A.; Francis I. L.; Hoj, P.; Gishen, M. The use of near infrared spectroscopy for grape quality measurement. The Aust. New Zealand Grapegrower Winemaker 2003, 476a, 69-76.]. These techniques are however limited by pre-processing and sample preparation before analysis and in the case of wines and spirits, the analyte fluids need to removed from their original container.

Methods that utilize a single wavelength in the VIS region to assess oxidation (browning) of white wines in either coloured or non-coloured transparent clear bottles have been described [see for example Skouroumounis, G. K.; Kwiatkowski, M. J.; Sefton, M. A.; Gawel, R.; Waters, E. J. In situ measurement of white wine absorbance in clear and coloured bottles using a modified laboratory spectrophotometer. Australian Journal of Grape Wine Research 9, 138-148]. This technique has several practical drawbacks including its limited applicability to white and rose wine analysis, and the lack of robust relationship between single wavelength and wine value or composition in red wines.

International Patent Application PCT/US01/32547, the entire disclosure of which is incorporated herein by reference, describes an integrated wine quality sensor which is used to evaluate the condition and state of wine while still in the bottle. This arrangement includes a sensor element integrated into the side of the bottle and in some cases, a further sensor integrated into the bottle closure. When evaluating the wine, the sensor elements are connected to an external data collection device and measurements taken. However, this system is limited to the use of modified bottles and closures and is therefore not suited to wide scale analysis of bottled products.

### SUMMARY OF THE INVENTION

We have discovered that VIS-NIR spectroscopy in transflectance mode can be used to assess at least one characteristic of a fluid while still in its container.

According to one aspect, the present invention provides a method of assessing at least one characteristic of a fluid held in a container utilizing visible-near infrared (VIS-NIR) spectroscopy, the method comprising:

subjecting at least a part of the fluid in the container to VIS-NIR electromagnetic radiation;

obtaining at least a part of the VIS-NIR transflectance spectra of the fluid; and

correlating at least a part of the spectra obtained with a reference data set utilizing chemometric analysis to assess at least one characteristic of the fluid.

The detected spectra may be at least part of the transmission, reflectance or transflectance spectra.

The detected spectra is at least part of the transflectance spectra, wherein the transflectance spectra is obtained by transmitting electromagnetic radiation through the fluid, reflecting at least a part of the transmission spectra using a suitable reflecting surface and retransmitting through the fluid before being detected by the detector.

The assessment may be quantitative or qualitative, or both.

The analysis of the detected spectra may involve chemometric analysis.

The container may be any suitable container which has at least one area which is substantially transparent to VIS-NIR electromagnetic radiation at the wavelength used to perform the analysis. The container may be a coloured or non-coloured glass bottle.

The VIS-NIR electromagnetic radiation used may be in the range between about 350 and about 1100 nm.

In particularly preferred embodiments of the invention, the fluid may be a beverage. The beverage may be any drinkable alcoholic and/or non-alcoholic beverage, including milk-based, fruit-based and/or fermented beverages. The beverage is a fermented beverage, such as one selected from the group comprising beer, ale, spirits, wine, sparkling wines and mixtures thereof. The fermented beverage may be a wine or wine product.

The wine may be a “red” wine or a “white” wine, sparkling, rose or fortified and may be selected from the group comprising in particular Riesling; Traminer; Frontignac; Sauvignon Blanc; Verdelho; Semillon; Pinot Noir; Cabernet Franc; Chenin Blanc; Chardonnay; Chambourcin; Merlot; Shiraz; Cabernet Sauvignon; and Grenache; their respective blends, plus wines made from other grape varieties used for winemaking.

At least one characteristic of the wine assessed by the present invention may be selected from one or more from the group comprising: quality, pigments selected from the group comprising yellow, orange, brown and red, sugars, pH, total acidity, volatile acidity, density, specific gravity, degree of fermentation, spirit indication (alcohol), sensory attributes (e.g. oxidation or browning), free and total sulphur dioxide concentration, and/or other characteristics that may be indicative of wine quality value.

Thus the invention provides a non-destructive method for analysing wine without the need to open the wine bottle.

Non-limiting examples of characteristics that are indicative of wine quality include any one or more of the following: galacturonic acid; gums; polysaccharides of arabinose and galactose; tartaric acid; malic acid; citric acid; succinic acid; lactic acid; acetic acid; potassium bitartrate; formic; organic acids such as; oxalic acid; pyruvic acid; butyric acid; iso-butyric acid; hexanoic acid; octanoic acid; Ketoglutaric acid; alcohols such as; ethanol; methanol; isopropanol; n-butanol; isobutanol; n-amyl alcohol; 3-methylbutanol; 2-methylbutanol; n-hexanol; 2-phenylethanol; polyalcohol (polyols) such as; 2,3-butandiol; glycerol; erythritol; xylitol; arabitol (also called arabinitol); mannitol; acetaldehyde; acetoin and diacetyl; acetate; butyrate; oxanoate and other esters; ethyl acetate; ethyl formate; propyl acetate; isopropyl acetate; isobutyl acetate; isoamyl acetate; phenylethyl acetate; Esters such as; methyl ester n-propanol ethyl propionate; ethyl valerate; ethyl hexanoate (caproate); ethyl octanoate (caprylate); ethyl decanoate (caprate); ethyl lactate; ethyl succinate (acidic ester); methyl o-anthranilate; amino acids; diammonium phosphate; proteins; nitrates; amino acid esters; vitamins; biotin; choline; gallic acid; coutaric acid; caftaric acid; fertaric acid; catechin; epicatechin; epicatechin gallate; procyanidin (B1, B2, B3); catechin gallate; hydroxycinnamic acid esters (coutaric, caftaric, fertaric); acids; glutathionyl caftaric acid; catechin+epicatechin; afzelechin; epigallocatechin; flavane (3,4) diol; flavonol-3; potassium; sodium; calcium; iron; lithium; magnesium; copper; lead; manganese; aluminium; zinc; rubidium; arsenic; nickel; anions; phosphate; sulfate; borates; silicates; halogens; fatty acids; boron; fluorine; silicon; phosphate; sulphate; chlorine; bromine; iodine; anions, sulphur dioxide; acetaldehyde-bisulfite (bound SO₂); fumaric acid; vinylbenzene; benzaldehyde; nonalactone; ethyl phenylacetate; p-hydroxybenzoic acid; p-pyrocatechuic acid; gallic acid; vanillic acid; syringic acid; salicyclic acid; o-pyrocatechuic acid; gentisic acid; cinnamic acid; p-coumaric acid; caffeic acid; ferulic acid; sinapic acid; coutaric acid; caftaric acid; fertaric acid; digallic acid; ellagic acid; flavonoids; afzelechin; glycosides; tannins; flavylium ion; anthocyanins; cyanidin; delphinidin; peonidin; petunidin; malvidin; ethyl acetate; ethyl caproate; terpenoids; pyrazines; phenolics; chlorogenic acid; methyl anthranilate; ethyl anthranilate; methyl salicylate; ethyl salicylate; 2-methoxymethyl benzoate; 2-methoxyethyl benzoate; ethyl trans-2-butenoate; ethyltrans-2-hexenoate; ethyl trans-2-octenoate; ethyl trans-2-decenoate; ethyl trans-trans-2,4 decadienoate; ethyl trans-cis-2,4-decadienoate; ethyl trans,trans,cis-2,4,7-decatrienoate; ethyl trans,cis-2,6-dodecadienoate; methyl 3-hydroxybutanoate; 3-hydroxybutanoate; ethyl 3-hydroxyhexanoate; damascenone; furaneol; methoxyfuraneol; ethyl 3-mercaptopropanoate; trans-2-hexen-1-ol; hydrogen disulfide; carbon disulfide; dimethyl disulfide; dimethyl sulfide; diethyl sulfide; diethyl disulfide; methanethiol; ethanethiol; dimethyl sulfoxide; methyl thiolacetate; ethyl thiolacetate; cis and trans-2-methylthiophan-3-ol; 5-[hydroxyethyl]-4-methylthiazole; thio aliphatic alcohols; methionol or 3-(methylthio)-propanol; polyphenol oxidases; laccase; chlorogenic acid; protocatechuic acid; glutathione; 2-S-glutathionylcaftaric acid; acetaldehyde; 13⁻C-Norisoprenoids; 1,1,6-trimethyl 1,2-dihydronaphthalene(TDN); vitispirane; lignins; gallic acid; aromatic aldehydes; vanillin; syring aldehyde; coniferyaldehyde; sinapaldehyde; maltol; cyclotene; ethoxylactone; furfural; furfuryl alcohol; guaiacol; geosmin; malvidin glucoside; quinones; tartaric acid; potassium bitartrate; calcium tartrate; calcium carbonate; sorbic acid; ethyl sorbate; benzoic acid and sodium benzoate; diethyl dicarbonate(DEDC); dimethyl dicarbonate(DMDC); hydrogen sulfide; mercaptan; diethyl sulfide; ethyl mercaptan; pH, diacetyl, acetoin, 2,3-butandiol; 2-ethoxyhexa-3,5-diene; histamine; tyramine; putrescine; cadaverine; ethyl carbamate; urea and carbamyl phosphate.

The method of the invention provides a rapid, non-destructive method to determine the quality of wine by measuring a wide variety of wine characteristics. These measurements can be used by winemakers to monitor their product on a regular basis and used to determine the optimum time to release the product for retail sale.

Since individual tastes are different, the user can base the decision on their personal analysis of the measured parameters. The technique could therefore be used by bottle shops, restaurants, and individuals to determine the suitability of the wine for drinking.

In another aspect, the present invention provides a method for determining the response of a visible-near infrared (VIS-NIR) analyser(s) for one or more characteristic(s) of a fluid held in a container comprising:

for each characteristic(s) of interest, providing a database or library, by analysing a series of samples using standard laboratory techniques and correlating the results with their VIS-NIR transflectance spectra, utilizing the database or library to establish a chemometric model for the characteristic(s).

A chemometric model for at least one characteristic of a wine or wine product held in a container, the chemometric model produced by

subjecting a wine or wine product held in a container to VIS-NIR electromagnetic radiation;

obtaining at least part of the VIS-NIR transflectance spectra of the wine or wine product;

correlating the spectra obtained to reference analytical data utilizing chemometric analysis of the spectral data.

The chemometric analysis may be based on eigenvalue decomposition of the experimental data. The eigenvalue decomposition may utilize principal component analysis (PCA) and partial least squares in latent variables (PLS).

### BRIEF DESCRIPTION OF THE DRAWINGS

FIG. 1 illustrates the second derivative of the mean spectrum of pure ethanol and Milli-Q water through a glass beaker (400-1100 nm).

FIG. 2 illustrates the second derivative of the spectra of white wines scanned through a glass ampoule and the corresponding spectra with an empty ampule in the VIS-NIR region (400-1100 nm).

FIG. 3 illustrates the second derivative of the spectra of both red and white wines scanned in commercial bottles.

FIG. 4 illustrates the PCA analysis of white wine spectra: plot of PC1 and PC2 scores characterize oxidation of wine samples.

FIG. 5 illustrates predicted values.

FIG. 6(a) illustrates the second derivative plot of samples in calibration set.

FIG. 6(b) illustrates the second derivative plot of samples in a validation set.

### DETAILED DESCRIPTION OF THE INVENTION

The present invention will now be described with particular reference to the analysis of wine. However, it will be clear that a similar technique may be utilized for other beverages, including other alcoholic beverages and fruit juices or mixtures thereof.

It is therefore desirable that the present invention provides improved methodology for the analysis of fluids which is applicable over a wide range of samples.

It is also desirable that the present invention provides improved methodology for the analysis of fluids which is non-destructive and relatively rapid to perform.

It is also desirable that the present invention provides improved methodology for the analysis of fluid products which can be performed without the need to remove them from their container.

Moreover, it is desirable to provide a relatively simple, non-invasive and non-destructive method for the in-bottle analysis of wine.

VIS-NIR spectroscopy may be performed in transflectance mode. In this sample presentation mode, electromagnetic radiation is transmitted through the sample and then reflected using a suitable reflecting surface, and retransmitted through the sample before finally reaching the detector.

Non-limiting examples of suitable reflecting surfaces include aluminium and gold foil, metallic mirrors, such as stainless steel mirrors, reflecting silicon dioxide, etc.

In particular embodiments of the invention, there is provided a method for assessing the characteristics of a fluid held in a container using wavelengths of both visible radiation (350-699 nm) specifically chosen to include absorption bands for yellow colour pigments (350-499 nm), red colour pigments (500-600 nm) and near infrared (NIR) radiation (700-1100 nm) to correlate characteristics of the wine including sugars, pH, volatile acidity (VA), total acidity, density, colour, free and total sulphur dioxide concentration, and sensory characteristics, correlating these to make an assessment of the quality of the wine.

### Description of Non-Limiting Embodiments of the Invention

### Materials and Methods

### White Wine Bottles

A total of 141 white bottled wines were used. The bottled wine analysed were sourced from different styles, varieties and closure types. Additionally, white wines from research trials and commercial Chardonnay wine 2003 vintage bottled under natural and synthetic closures were also scanned in order to investigate differences in spectrum due to both the closure type and storage time. For the white wine, bottles used were Burgundy (750 mL) type French Green A 15588 (80.5 mm diameter 283 mm height) and Claret (750 mL) type Flint (75.6 to 78.0 mm diameter).

### Instrument and Spectra Collection

Wine bottles were scanned in transflectance mode (400-1100 nm) using a scanning monochromator FOSS NIRSystems 6500 (FOSS NIRSystems, Silver Spring, Md., USA). Samples were presented facing the instrument detectors, sealed in the back with aluminium foil and covered with a black fabric, in order to avoid light entering to the system. Spectral data were collected using Vision software (version 1.0, FOSS NIRSystems, Silver Spring, USA) and stored as the logarithm of the reciprocal of reflectance [log(1/R)] at two nm intervals (350 data points). The spectrum of each sample was the average of 32 successive scans. Due to operative reasons (e.g. initial problems with sample presentation set up), spectral trimming was performed and the region between 600-1100 nm was used to develop the different models and to interpret the spectra for each type of wine.

### Chemometric Analysis and Interpretation

In order to make quantitative measurements or qualitative discriminations between samples, chemometric models were developed for each parameter. The model is a mathematical construct developed using samples of the same product or class of products. A chemometric model is developed by collecting spectral readings from a group of samples that display (a) the maximum variability of the characteristic of interest, and (b) non-correlating or random variability in all other characteristics. The same samples are submitted for independent testing to measure the characteristic of interest by a standard analytical method. The spectral data and independent test data were then analysed using commercially available chemometrics software. The statistical processes used in quantitative spectral analysis include multiple linear regression, classical least squares, inverse least squares, and principal component regression. The statistical processes used in qualitative spectral analysis include K-nearest neighbours (KNN), linear discriminant analysis (LDA), soft independent modelling of class analogies (SIMCA) and others.

When a sufficient number of samples were collected (spectra) and properly analysed (reference method), a mathematical model is constructed that describes the relationship between specific spectral features and the sample characteristics of interest.

Thus spectra were exported from the Vision software in NSAS format to the Unscrambler software (version 7.5, CAMO ASA, Norway) for both spectral and chemometric analysis. Before performing principal component analysis (PCA), spectra were centred and autoscaled, and pre-processed using the second derivative to reduce baseline variation and enhance the spectral features. Second derivative was performed using Savitzky-Golay derivation and smoothing (20 point and 2nd order filtering operation). PCA is a mathematical procedure for resolving sets of data into orthogonal components whose linear combinations approximate the original data to any desired degree of accuracy. PCA was used to derive the first few principal components from the spectral data and was used to examine the possible grouping of samples. Partial least squares regression (PLS) between spectra and chemical reference data were developed using cross validation. The optimum number of terms in the PLS calibration models were determined by full cross validation. Statistics calculated included the coefficient of determination in calibration (R²_{cal}), the standard error in calibration (SEC) and the standard error in cross validation (SECV). Bottle samples were analysed for alcohol content, pH, free and total sulphur dioxide, and volatile acidity using standard laboratory techniques.

### Results

### Effect of Path Length and Type of Bottle on the Spectra

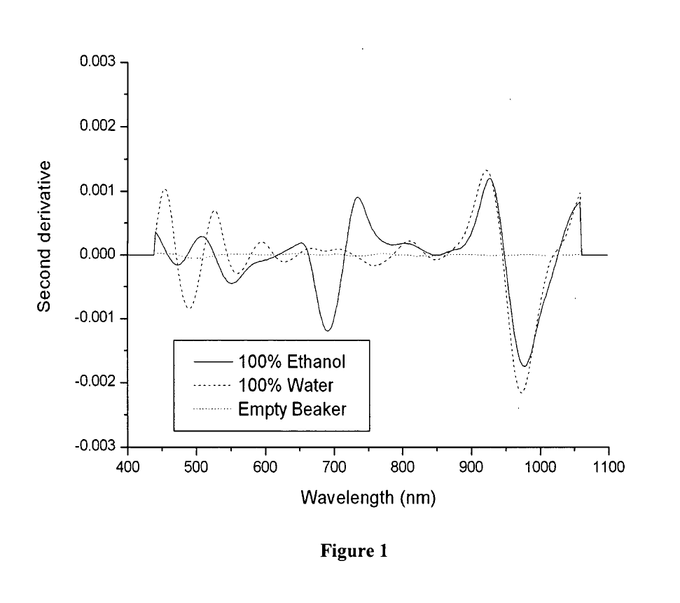

FIG. 1 shows the second derivative of the mean spectrum of pure ethanol and Milli-Q water through a glass beaker. The second derivative of pure ethanol shows absorption bands in the VIS region around 690 nm, and in the NIR region around 890 nm related with C—H stretch third overtone and with CH₃ stretch third overtone and 968 nm related with O—H stretch third overtone. Second derivative of Milli-Q water in the NIR region shows absorption bands around 978 nm related with O—H stretch third absorption bands, respectively. The broad region between 900 and 1050 nm is related to the second overtones of O—H stretching of both ethanol and water. The second derivative of the spectra of the glass beaker without sample did not have any spectral feature in the NIR region, corresponding almost with the zero line. The background spectrum from the glass beaker is observed to be very small. These results showed that it is possible to measure liquids using a glass container.

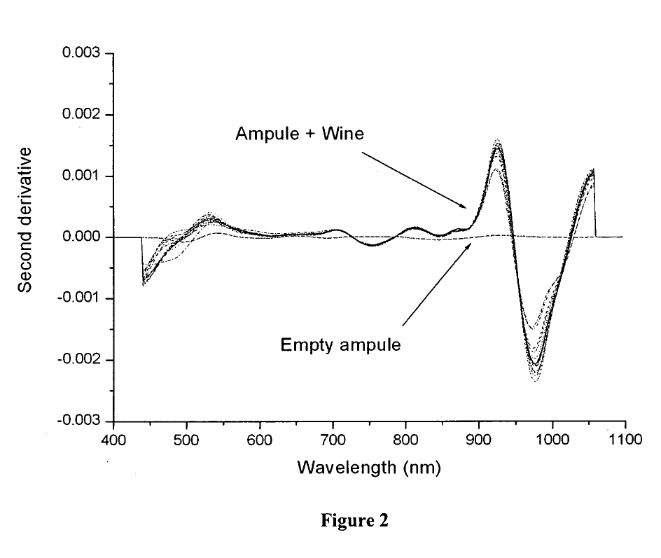

FIG. 2 shows the second derivative of the spectra of white wines scanned through a glass ampoule. The second derivative of the spectra of the white wine samples shows absorption at 756 nm related with O—H stretch third overtone, at 850 nm related with both C—C and C—H stretch third overtone, and 980 nm related to O—H stretch second overtone bands of water and ethanol, respectively.

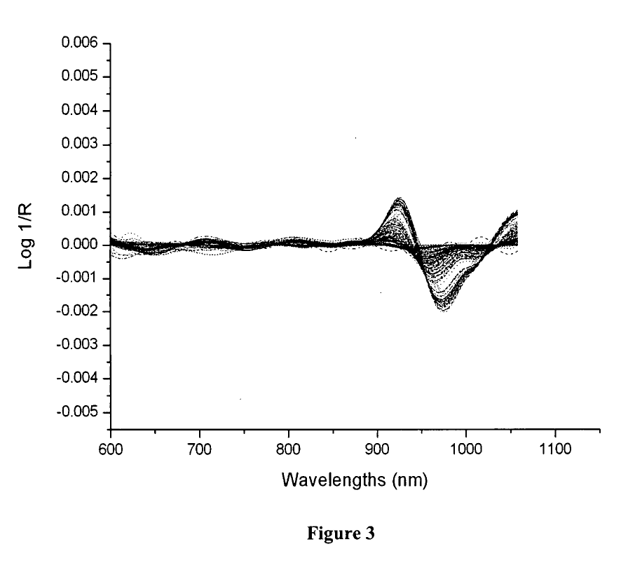

FIG. 3 shows the second derivative of the spectra of both red and white wines scanned in commercial bottles. The second derivative shows three absorption bands at 925 nm, 970 nm and at 1050 nm corresponding to those described above related with O—H second overtones of ethanol and water, respectively. No absorption bands were described in the VIS region due to high level of noise related with sample presentation. Overall, the second derivate of wines analysed in the bottle showed that it is possible to measure some chemical parameters in the wine without taking the fluid out of its original container.

### Monitoring White Wine Oxidation

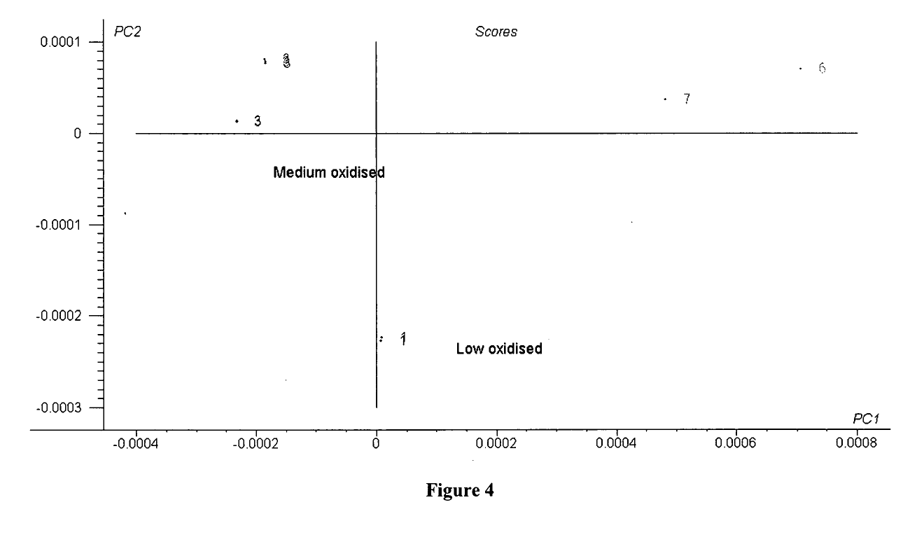

FIG. 4 shows the eigenvectors for the first two principal components (PC1 vs. PC2) derived from the second derivative of the spectra (600-1100 nm) of the set of white wine analyzed. Separation was observed between bottled samples related to different degree of oxidation (browning). FIG. 4 demonstrates the monitoring of wine bottles with different degree of oxidation is possible, and that this is related to different spectral attributes. The loading for those principal components showed features around 700 and 900 nm. PC1 explained 96% of the variation, its loadings showing a valley around 930 nm and a peak at 980 nm both associated with O—H and C—H absorption bands, related to water and ethanol. PC2 explained 3% of the variation, showing loadings at 670 nm, 770 nm, 838 nm, 918 nm, at 954 nm and 990 nm related to O—H and C—H vibrations, respectively.

### Determination of Wine Quality Value—PLS Calibrations

Table 1 shows PLS calibration models developed for different chemical wine quality attributes namely ethanol content (%), free and total sulphur dioxide (mg/L), volatile acidity (g/L) determined by chemical methods, and oxidized and reduced characters determined by a panel of trained experts.

TABLE 1
The PLS calibration models developed for different
chemical wine quality attributes namely ethanol content (%),
free and total SO₂ (mg/L), volatile acidity (g/L),
and oxidized and reduced characters.

| | n | R²_{cAL} | SECV | PLS terms |
|---|---|---|---|---|
| Ethanol (%) | 85 | 0.74 | 0.70 | 4 |
| Free SO₂ (mg/L) | 95 | 0.67 | 6.0 | 3 |
| Total SO₂ (mg/L) | 117 | 0.73 | 28.1 | 8 |
| VA (g/L) | 55 | 0.50 | 0.19 | 3 |
| Reduced | 30 | 0.57 | 0.13 | 8 |
| Oxidized | 30 | 0.92 | 0.62 | 8 |

The calibrations models were developed using full cross validation and are used only as an indication of the ability of the VIS-NIR to predict these parameters. For the sensory attributes the best calibration statistics were obtained for reduced aroma characters where a correlation coefficient (r) and standard error in cross validation (SECV) of 0.96 and 0.62 was observed, for reduced character 0.72 and 0.13 respectively. The calibration statistics for total sulphur dioxide (R²_{cal}=0.73; SECV=28.1 mg/L), free sulphur dioxide (R²_{cal}=0.67; SECV=6.0 mg/L), alcohol (R²_{cal}=0.74; SECV=0.70 mg/L) suggested that this application (in bottle analysis) would provide indicative results. The results clearly demonstrate that the determination of some chemical and sensory attributes is possible in an unopened wine bottle.

Measurements on different empty bottles revealed small differences probably due to slight variation in wall thickness. As the calibration samples were scanned in standard commercial wine bottles, any such variation can be incorporated directly in the calibration models. Any significant change to the bottle (e.g. wall thickness) by the manufacturer can require the setting up of new calibration models. In the examples above, it was shown that neither the path length of the bottle (wall thickness) nor the type of bottle (e.g. colour and shape of the bottle) affected the interpretation of the VIS-NIR spectra of wavelengths related with ethanol and water.

The absorption bands of the sample analysed are unique and generally less sharp at longer wavelengths and yield poorer spectral resolution. Despite this, it is possible to monitor changes in wines related to changes due to chemical compounds. The application of such approach gives the wine industry a very fast and non destructive method to look for example at the oxidation process that normally occur in white wine as well as to detect other unwanted problems in the wine prior to selling.

### Validation

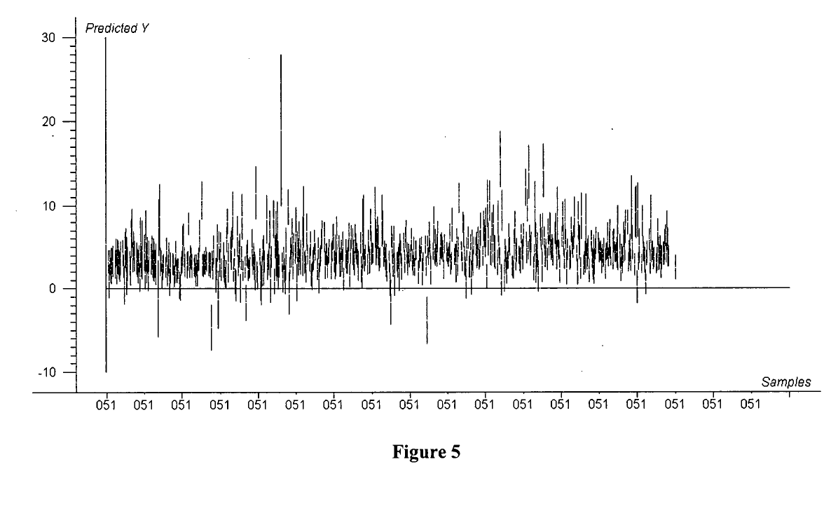

In order to develop a calibration for oxidation, commercial Riesling samples were scanned and assessed by the winemaker. The samples were assigned with the score value of 8 (highly oxidized) and with the number 0 (no oxidize). The scores were used to develop a PLS calibration to predict oxidation in unknown samples. Second derivative was used as spectra pre processing. The calibration statistics were: R²_{cal}=0.94 (SEC=0.46) and R²ᵥₐₗ=0.80 (SECV=1.37). More than 700 bottles were scanned in the winery and predicted using the equations developed. The predicted values are shown in FIG. 5.

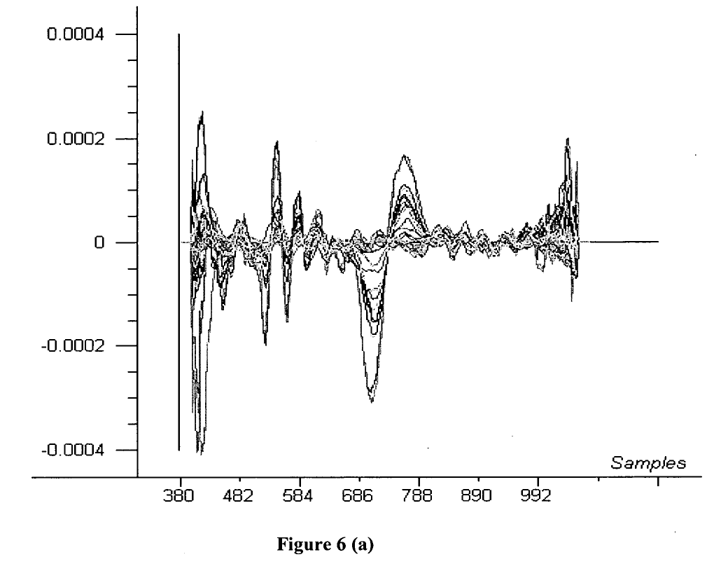

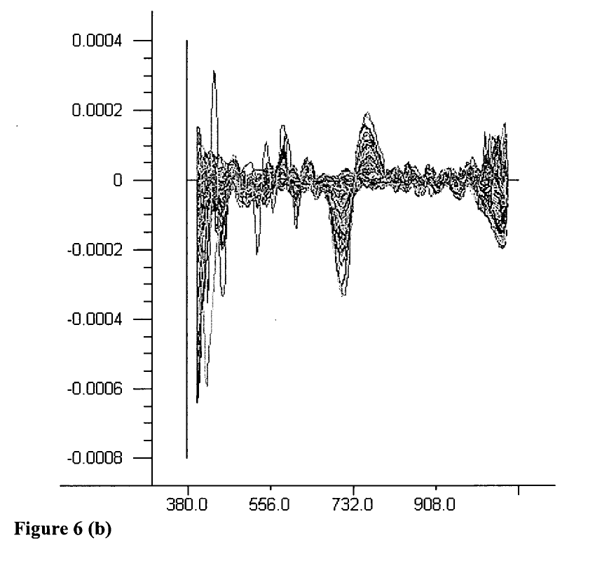

FIGS. 6(a) and 6(b) shows the second derivative spectra of samples in the calibration set and in the validation set, respectively. Note that the wavelength region between 480 to 800 nm were similar in the different set of samples.

The results demonstrate that VIS-NIR spectroscopy can be used to assess wine composition while still in the bottle. These results also demonstrate that VIS-NIR spectroscopy together with chemometric techniques (e.g. PCA, PLS) can be used to monitor wine composition during or after bottling. The results show that VIS-NIR techniques are useful for the analysis of wine quality without the need for costly and laborious standard chemical and sensory assessment of the wine by a trained panel.

In order to augment interpretation of spectral data and minimize effects of instrument drift, each winery can maintain a group of control bottles. Each year some bottles from a larger sample set could be first measured using the present invention and then opened to measure one or more of the indicative characteristics accurately using proven laboratory techniques.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of assessing at least one characteristic of a fluid held in an original container utilizing visible-near infrared (VIS-NIR) spectroscopy, the method comprising:
subjecting at least a part of the fluid in the container to VIS-NIR electromagnetic radiation;
obtaining at least a part of the VIS-NIR transflectance spectra of the fluid; and
correlating at least a part of the spectra obtained with a reference data set utilizing chemometric analysis to assess at least one characteristic of the fluid.

2. The method according to claim 1, wherein the transflectance spectra is obtained by transmitting electromagnetic radiation through the fluid, reflecting at least a part of the transmission spectra using a suitable reflecting surface and retransmitting through the fluid before being detected by the detector.

3. The method according to claim 1, wherein assessment is quantitative or qualitative and/or both.

4. The method according to claim 1, further comprising performing chemometric analysis of the obtained VIS-NIR reflectance spectra.

5. The method according to claim 1, wherein the container has at least one area which is substantially transparent to VIS-NIR electromagnetic radiation at the wavelength used to perform the analysis.

6. The method according to claim 1, wherein the original container is a beverage container.

7. The method according to claim 1, wherein the original container is a coloured or uncoloured and/or transparent glass bottle.

8. The method according to claim 1, wherein the original container is a wine bottle.

9. The method according to claim 1, wherein the VIS-NIR electromagnetic radiation used is in the range between about 350 and about 1100 nm.

10. The method according to claim 1, wherein the fluid is a beverage.

11. The method according to claim 1, wherein the fluid is an alcoholic beverage.

12. The method according to claim 1, wherein the fluid is a fermented beverage.

13. The method according to claim 1, wherein the fluid is selected from the group comprising beer, ale, spirits, wine, sparkling wines and mixtures thereof.

14. The method according to claim 1, wherein the fluid is a wine or wine product.

15. The method according to claim 1, wherein the fluid is selected from the group comprising a “red” wine or a “white” wine, sparkling, rose and/or a fortified wine.

16. The method according to claim 1, wherein the fluid is a wine and is selected from group comprising Riesling; Traminer; Frontignac; Sauvignon Blanc; Verdelho; Semillon; Pinot Noir; Cabernet Franc; Chenin Blanc; Chardonnay; Chambourcin; Merlot; Shiraz; Cabernet Sauvignon; and Grenache; and blends thereof.

17. The method according to claim 1, wherein the at least one characteristic of the fluid assessed is selected from one or more of the group comprising: quality, pigments selected from the group comprising yellow, orange, brown and red, sugars, pH, total acidity, volatile acidity, density, specific gravity, degree of fermentation, spirit indication (alcohol), sensory characteristics (e.g. oxidation or browning), free and total sulphur dioxide concentration, and/or other characteristics that is indicative of wine quality value.

18. The method according to claim 1, wherein the fluid is wine and the characteristics that are indicative of wine quality include any one or more from the group comprising: galacturonic acid; gums; polysaccharides of arabinose and galactose; tartaric acid; malic acid; citric acid; succinic acid; lactic acid; acetic acid; potassium bitartrate; formic; organic acids such as; oxalic acid; pyruvic acid; butyric acid; iso-butyric acid; hexanoic acid; octanoic acid; Ketoglutaric acid; alcohols such as; ethanol; methanol; isopropanol; n-butanol; isobutanol; n-amyl alcohol; 3-methylbutanol; 2-methylbutanol; n-hexanol; 2-phenylethanol; polyalcohol (polyols) such as; 2,3-butandiol; glycerol; erythritol; xylitol; arabitol (also called arabinitol); mannitol; acetaldehyde; acetoin and diacetyl; acetate; butyrate; oxanoate and other esters; ethyl acetate; ethyl formate; propyl acetate; isopropyl acetate; isobutyl acetate; isoamyl acetate; phenylethyl acetate; Esters such as; methyl ester n-propanol ethyl propionate; ethyl valerate; ethyl hexanoate (caproate); ethyl octanoate (caprylate); ethyl decanoate (caprate); ethyl lactate; ethyl succinate (acidic ester); methyl o-anthranilate; amino acids; diammonium phosphate; proteins; nitrates; amino acid esters; vitamins; biotin; choline; gallic acid; coutaric acid; caftaric acid; fertaric acid; catechin; epicatechin; epicatechin gallate; procyanidin (B1, B2, B3); catechin gallate; hydroxycinnamic acid esters (coutaric, caftaric, fertaric); acids; glutathionyl caftaric acid; catechin+epicatechin; afzelechin; epigallocatechin; flavane (3,4) diol; flavonol-3; potassium; sodium; calcium; iron; lithium; magnesium; copper; lead; manganese; aluminium; zinc; rubidium; arsenic; nickel; anions; phosphate; sulfate; borates; silicates; halogens; fatty acids; boron; fluorine; silicon; phosphate; sulphate; chlorine; bromine; iodine; anions, sulphur dioxide; acetaldehyde-bisulfite (bound SO₂); fumaric acid; vinylbenzene; benzaldehyde; nonalactone; ethyl phenylacetate; p-hydroxybenzoic acid; p-pyrocatechuic acid; gallic acid; vanillic acid; syringic acid; salicyclic acid; o-pyrocatechuic acid; gentisic acid; cinnamic acid; p-coumaric acid; caffeic acid; ferulic acid; sinapic acid; coutaric acid; caftaric acid; fertaric acid; digallic acid; ellagic acid; flavonoids; afzelechin; glycosides; tannins; flavylium ion; anthocyanins; cyanidin; delphinidin; peonidin; petunidin; malvidin; ethyl acetate; ethyl caproate; terpenoids; pyrazines; phenolics; chlorogenic acid; methyl anthranilate; ethyl anthranilate; methyl salicylate; ethyl salicylate; 2-methoxymethyl benzoate; 2 methoxyethyl benzoate; ethyl trans-2-butenoate; ethyltrans-2-hexenoate; ethyl trans-2 octenoate; ethyl trans-2-decenoate; ethyl trans-trans-2,4 decadienoate; ethyl trans-cis-2,4-decadienoate; ethyl trans,trans,cis-2,4,7-decatrienoate; ethyl trans,cis-2,6 dodecadienoate; methyl 3-hydroxybutanoate; 3-hydroxybutanoate; ethyl 3 hydroxyhexanoate;
damascenone; furaneol; methoxyfuraneol; ethyl 3 mercaptopropanoate; trans-2-hexen-1-ol; hydrogen disulfide; carbon disulfide; dimethyl disulfide; dimethyl sulfide; diethyl sulfide; diethyl disulfide; methanethiol; ethanethiol; dimethyl sulfoxide; methyl thiolacetate; ethyl thiolacetate; cis and trans-2-methylthiophan-3-ol; 5-[hydroxyethyl]-4-methylthiazole; thio aliphatic alcohols; methionol or 3-(methylthio)-propanol; polyphenol oxidases; laccase; chlorogenic acid; protocatechuic acid; glutathione; 2-S-glutathionylcaftaric acid; acetaldehyde; 13-C-Norisoprenoids; 1,1,6-trimethyl 1,2-dihydronaphthalene(TDN); vitispirane; lignins; gallic acid; aromatic aldehydes; vanillin; syring aldehyde; coniferyaldehyde; sinapaldehyde; maltol; cyclotene; ethoxylactone; furfural; furfuryl alcohol; guaiacol; geosmin; malvidin glucoside; quinones; tartaric acid; potassium bitartrate; calcium tartrate; calcium carbonate; sorbic acid; ethyl sorbate; benzoic acid and sodium benzoate; diethyl dicarbonate(DEDC); dimethyl dicarbonate(DMDC); hydrogen sulfide; mercaptan; diethyl sulfide; ethyl mercaptan; pH, diacetyl, acetoin, 2,3-butandiol; 2-ethoxyhexa-3,5-diene; histamine; tyramine; putrescine; cadaverine; ethyl carbamate; urea, carbamyl phosphate or combinations thereof.

19. A method for determining the response of a visible-near infrared (VIS-NIR) analyser(s) for one or more characteristic(s) of a fluid held in an original container comprising:
for each characteristic(s) of interest, providing a database or library, by analysing a series of samples using standard laboratory techniques and correlating the results with their VIS-NIR transflectance spectra,
utilizing the database or library to establish a chemometric model for the characteristic(s).

20. A chemometric model for at least one characteristic of a wine or wine product held in an original container, the chemometric model produced by
subjecting at least part of a wine or wine product held in the container to VIS-NIR electromagnetic radiation;
obtaining at least part of the VIS-NIR transflectance spectra of the wine or wine product;
correlating the spectra obtained to reference analytical data utilizing chemometric analysis of the spectral data.

21. The chemometric model according to claim 20, wherein the chemometric analysis is based on eigenvalue decomposition of the experimental data.

22. The chemometric model according to claim 20, wherein the chemometric analysis is based on eigenvalue decomposition utilizing principal component analysis (PCA) and partial least squares in latent variables (PLS).
